(19) United States
(12) Patent Application Publication
(10) Pub. No.: US 2008/0208615 A1
(43) Pub. Date: Aug. 28, 2008

(54) Methods and Apparatus for Performing Task Management Based on User Context

(75) Inventors: Guruduth Somasekhara Banavar, Yorktown Heights, NY (US); John Sidney Davis, New York, NY (US); Maria Rene Ebling, White Plains, NY (US); Daby Mousse Sow, Bronx, NY (US)

Correspondence Address: RYAN, MASON & LEWIS, LLP, 90 FOREST AVENUE, LOCUST VALLEY, NY, 11560, US

(73) Assignee: International Business Machines Corporation, Armonk, NY (US)

(21) Appl. No.: 12/114,346

(22) Filed: May 2, 2008

Related U.S. Application Data
(63) Continuation of application No. 10/854,669, filed on May 26, 2004.

(51) Int. Cl. G06Q 99/00; G06F 17/00

(52) U.S. Cl. 705/1

(57) ABSTRACT

Task management techniques based on user context are provided. More particularly, techniques are presented for calculating task attribute values based on user context data. Once task attributes of a user have been determined, the tasks can be prioritized and a suggestion can be made to the user to perform the tasks in the given order. In a first aspect of the invention, a computer-based technique for scheduling at least one task associated with at least one user includes obtaining context associated with the at least one user, and automatically determining a schedule for the at least one user to perform the at least one task based on at least a portion of the obtained context and based on one or more task attributes associated with the at least one task.

### CROSS-REFERENCE TO RELATED APPLICATION(S)

This application is a continuation of U.S. application Ser. No. 10/854,669 filed on May 26, 2004, the disclosure of which is incorporated herein by reference.

### FIELD OF THE INVENTION

The present invention relates to task management techniques and, more particularly, to task management techniques based on user context.

### BACKGROUND OF THE INVENTION

As we enter the age of pervasive computing in which computer resources are available on an anytime, anywhere basis, computer users are finding themselves burdened with more responsibilities. Full connectivity leads to a slippery slope of responsibilities that are computer enabled. The World Wide Web and ubiquitous computer access suggest that a user can accomplish more tasks. By tasks we mean activities or actions for which a user is responsible. Example tasks include the completion of travel expense forms, approval of purchase orders, trip preparation planners, conference calls, meeting attendance and software update installation. Continual computing advancements impose corresponding increases in user responsibilities.

The difficult truth of the matter is that computer advancements are not matched by human improvements. The result is that humans are having difficulty keeping up with the various responsibilities for which they are called upon. They are often interrupted by system queries for their input in an ad-hoc manner, decreasing their productivity. Measures need to be taken to optimize efficiency so that the tasks assigned to humans can be accomplished.

Each of the responsibilities or tasks assigned to a user typically has a due date, a level of importance, and a duration. Organizing these task attributes is necessary in order to determine how to schedule tasks with respect to one another so that the user can accomplish the tasks in the best order. A challenge with task prioritization is that task attributes are typically dynamic and often depend on data about the user to which the tasks have been assigned.

As an example, consider the task of filling out an expense account form using an online tool (i.e., a software tool available over a distributed computing network such as the World Wide Web). For user A, this task might take T_{A} minutes while user B will only require T_{B} minutes (such that T_{B} is not equal to T_{A}). The value of T_{A} may vary based on user circumstances such as the availability of a high speed network connection. Furthermore, determining if user A has T_{A} minutes available to accomplish task A will depend on user A's circumstances.

All of these variables result in a difficult optimization problem. Requiring a human to solve this optimization problem results in a serious burden and this burden is often the cause of human time management problems.

### SUMMARY OF THE INVENTION

The present invention provides task management techniques based on user context.

By way of example, context may be data (information) about the environment (including physical and/or virtual) in which a given user is located, characteristics of a given user, and qualities of a given user. Context may also refer to data about a computational device that is being used by the user. Further, context may also be a combination of the above and other data. Examples of context may include, but are not limited to, location of the user, temperature of the environment in which the user is located, the state of executing software or hardware being used by the user, as well as many other forms of environmental information. Other examples of context may include, but are not limited to, calendar information of the user, an availability of the user, a workload of the user, one or more network resources available to the user, a device profile that the user has access to, and an identity of a person within a vicinity of the user. Given the teachings of the invention presented herein, one of ordinary skill in the art will realize various other context information that may be used.

More particularly, illustrative techniques are presented for calculating task attribute values based on user context data. Once task attributes of a user have been determined, the tasks can be prioritized and a suggestion can be made to the user to perform the tasks in the given order.

In a first aspect of the invention, a computer-based technique for scheduling at least one task associated with at least one user includes obtaining context associated with the at least one user, and automatically determining a schedule for the at least one user to perform the at least one task based on at least a portion of the obtained context and based on one or more task attributes associated with the at least one task.

The technique may also include the step of automatically formatting the schedule for use within a personal information management tool of the at least one user. Further, one of the one or more task attributes may include a task due date, a level of task importance, and a task duration. The technique may also include the step of obtaining the availability of the at least one user through at least one of a user specification and an analysis algorithm applied to obtained user context. Still further, the step of automatically determining a schedule may further include determining at least one of the one or more task attributes wherein at least one attribute of the attributes is determined using user context.

Still further, a task duration may be obtained explicitly from a user. A task duration may also be learned from a history of one or more previous task executions from the user. The step of automatically determining a schedule may further include determining at least one of the one or more task attributes wherein at least one attribute of the attributes is explicitly specified by the user via one or more preferences. The step of obtaining availability of the user may include applying a Q-learning algorithm to at least a portion of the user context.

In a second aspect of the invention, user tasks are assigned fixed attributes (i.e., due date, level of importance and duration) and user context is employed to determine if and when the user has an available time slot for completing the tasks. In such an aspect of the invention, a user's available time slots may be determined through explicit user specification or implicitly through analysis algorithms applied to collected user context.

In a third aspect of the invention, a user task is assigned a fixed due date and a fixed duration and user context is employed to determine the level of importance of the task so that the task can be scheduled appropriately. An example embodiment of a system employing context to determine the level of importance of a task may involve context from a user's location to determine importance of a task given geographically relevant services.

In a fourth aspect of the invention, a user task is assigned a fixed due date and a fixed level of importance and user context is employed to determine the duration of the task so that the task can be scheduled appropriately. An example embodiment of a system employing context to determine the duration of a task may involve context from a user's network resources to determine the difficulty of accomplishing a task (e.g., filling out a form on a high bandwidth website while using a low bandwidth connection).

In a fifth aspect of the invention, a user task is assigned some combination of fixed and varying due date, level of importance and duration such that context is employed to determine some or all of the due date, importance and difficulty attribute values to determine whether or not a task can be prioritized appropriately.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram of an exemplary, task management architecture for scheduling tasks based on user context and priorities, according to an embodiment of the present invention;

FIG. 2 is a flowchart of an exemplary method for predicting availability of a user for engaging in a task, according to an embodiment of the present invention;

FIG. 3 is a flowchart of an exemplary method for predicting execution duration of a given task, according to an embodiment of the present invention;

FIG. 4 is a flowchart of an exemplary method for prioritizing tasks, according to an embodiment of the present invention;

FIG. 5 is a flowchart of an exemplary method for scheduling tasks based on prioritization, user availability and execution duration, according to an embodiment of the present invention;

FIG. 6 is a block diagram illustrating a computer system suitable for implementing a task management system, according to an embodiment of the present invention;

FIG. 7 shows an exemplary format of a context database where context events are stored, according to an embodiment of the present invention;

FIG. 8 shows an exemplary format of a task database where tasks are stored, according to an embodiment of the present invention;

FIG. 9 shows an exemplary format of a priority database where task priorities are stored, according to an embodiment of the present invention;

FIG. 10 shows an exemplary format of a duration database where tasks duration statistics are stored, according to an embodiment of the present invention;

FIG. 11 shows an exemplary format of an availability database where user availability information is stored, according to an embodiment of the present invention;

FIG. 12 shows an exemplary format of a user feedback database where feedback from end users is stored, according to an embodiment of the present invention; and

FIG. 13 is a flowchart of an exemplary method for collecting user feedback, according to an embodiment of the present invention.

### DETAILED DESCRIPTION OF PREFERRED EMBODIMENTS

It is to be understood that while the present invention will be described below in terms of illustrative task types, the invention is not so limited. Rather, the invention is more generally applicable to any tasks and task attributes with which it would be desirable to provide improved task management techniques that are based on context. As used herein, the term “context” is generally understood to refer to information about the physical or virtual environment of the user and/or a computational device that is being used by the user.

Accordingly, pervasive, context-aware computing may be considered the process of automatically observing and making inferences on behalf of a user about environmental data from disparate sources. Recent advances in sensor technology as well as the development of widely accepted networking protocols enable the widespread emergence of pervasive, context-aware computing applications. Such applications leverage user context to form inferences about users.

Furthermore, computer users are finding themselves burdened with more responsibilities. The ability to engage in computer-based tasks at any time and from any where (a situation that is made possible through pervasive computing) implies that computer users are often expected to accomplish more of these computer-based tasks. Organizing and scheduling these computer-based tasks is a daunting problem for many users.

Principles of the present invention solve these and other problems by providing techniques that may be used to automatically schedule tasks for users to engage in so that users can avoid the decision making process of prioritizing the tasks themselves. The present invention provides techniques that permit tasks to be defined and attributes of those tasks to be inferred based on context about the user who will engage in the tasks. The user context enables the task attributes to be determined with a level of precision so that the tasks can be scheduled according to the optimum way in which they should be undertaken.

As an example of a set of tasks that can be scheduled by techniques of the present invention, consider a user who needs to engage in the task of filling out an electronic expense account form (task T_{A}), the task of approving a computer-based patent application approval form (task T_{B}), and the task of ordering equipment online (T_{C}). Based on user context such as the time of day, the available network speed and the presence of others along with user-specified levels of importance, the attributes of each of these tasks can be inferred. Once the task attributes have been determined, the tasks can be scheduled appropriately.

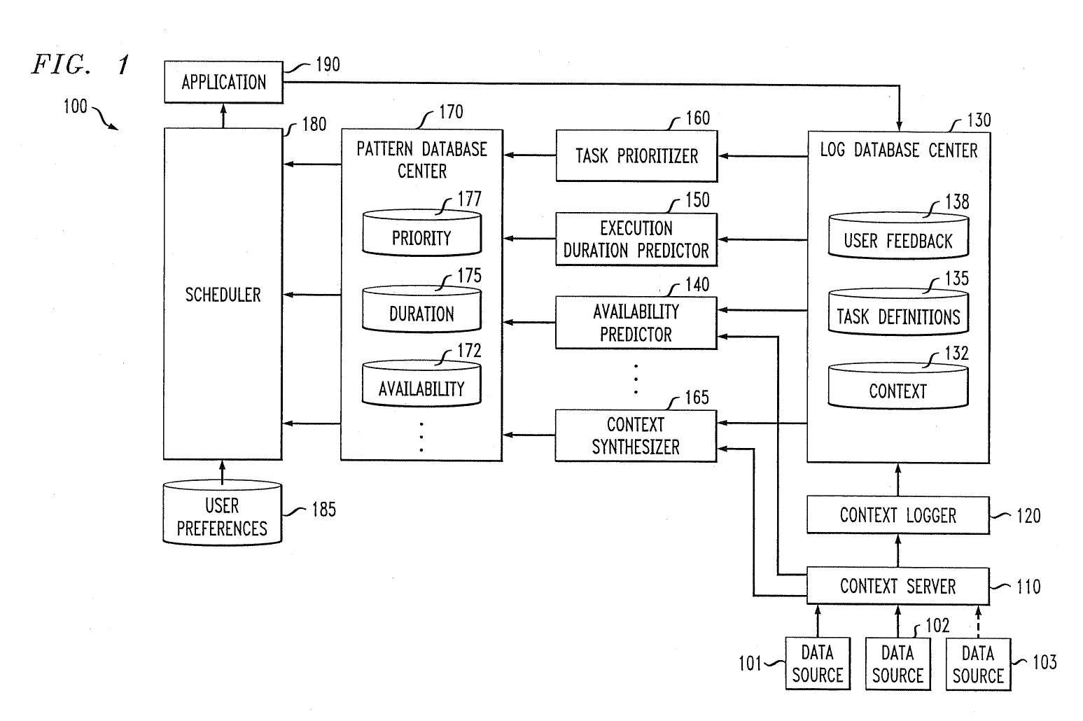

Referring initially to FIG. 1, a block diagram is shown of an exemplary, task management architecture for scheduling tasks based on user context and priorities, according to an embodiment of the present invention. It is to be appreciated that the components of the architecture may be resident in a single computer system or they may reside in multiple computer systems coupled as part of a distributed computing network (e.g., World Wide Web, local area network, etc.).

More particularly, in FIG. 1, an exemplary architecture for scheduling tasks based on user context and priorities is shown wherein context data is logged in a Log DB (database) Center 130 and patterns of the context data are determined in a Pattern DB Center 170 so that a Scheduler 180 can schedule tasks to be used by the realization of an application 190.

Data sources (e.g., context sources) 101, 102, 103 feed into a Context Server 110 which is monitored by a Context Logger 120. The Log DB Center 13 0 stores data logged by the Context Logger 120 in a Context database 132. A format of the Context Database 132 is shown in FIG. 7. Each entry in the database represents a context event consisting of a Type 710, a User 720, N attributes 730, 740, 750, 760, and a Time Stamp 770. Example types include location and calendar. Example attributes for a location type are the longitude and latitude of the location. The User field 720 contains a unique ID that identifies the subject of this entry. Definitions of the tasks to be scheduled are stored in a Task Definitions database 135. A format of the Task Database 135 is shown in FIG. 8. Each entry in the database represents an instance of a task consisting of a Type 810, a Priority 820, a Due Date 830, a Start Time 840, Time Stamp 850, a Task ID 860 and a User ID 870.

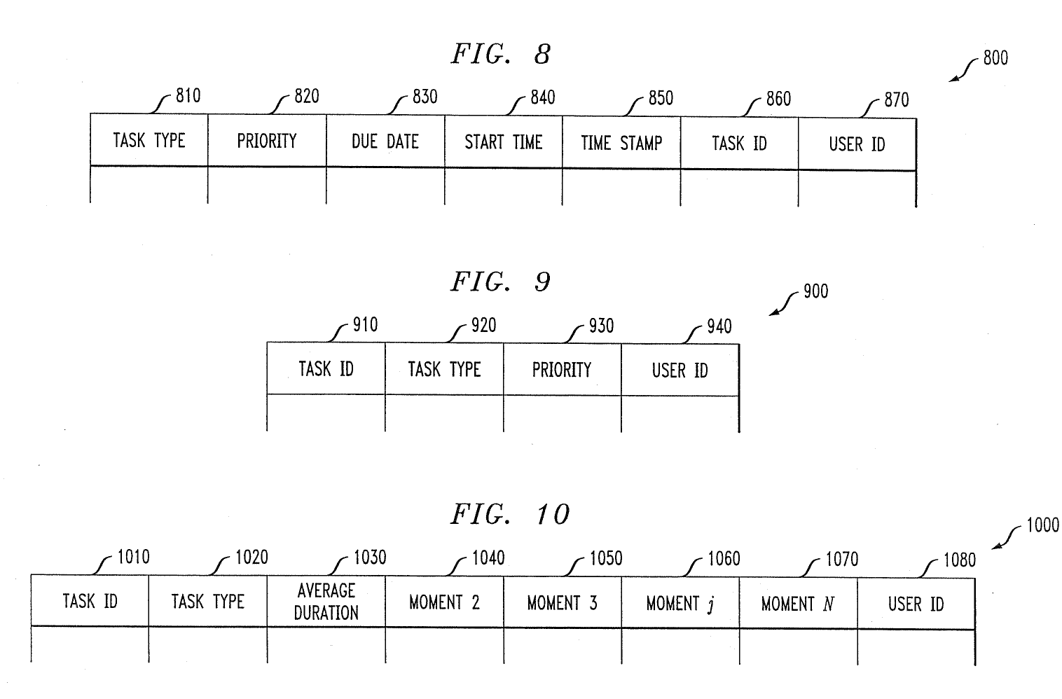

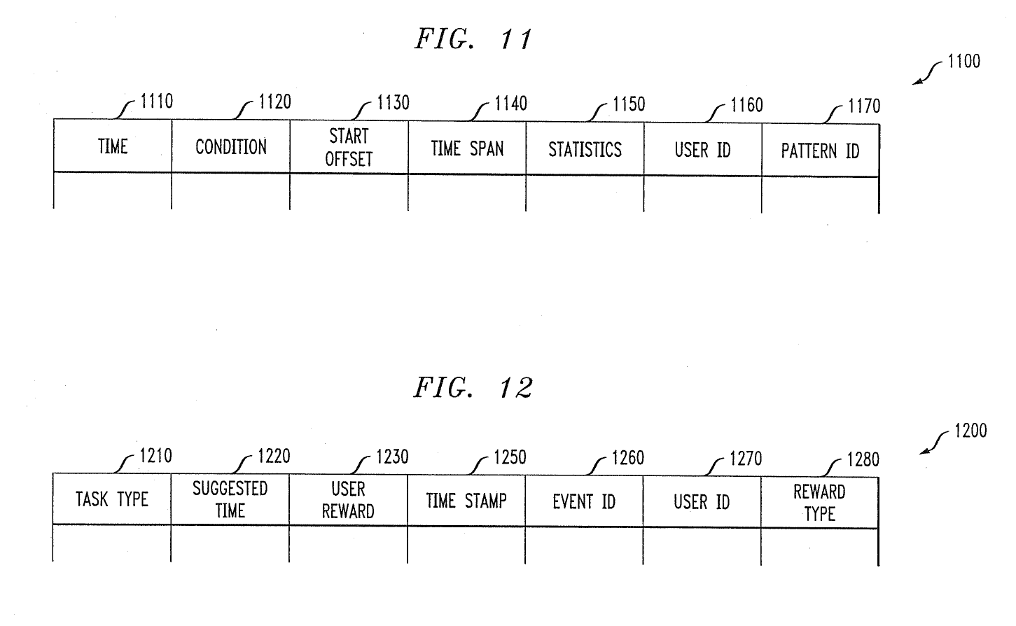

Based on the task definitions, a Task Prioritizer 160 prioritizes tasks and stores these prioritized tasks in a Priority database 177. A format of the Priority database 177 is shown in FIG. 9. Each entry in the database represents an instance of a task's priority consisting of a UID 910, Type 920, a Priority 930 and a User ID 940. Based on the task definitions and the logged context, an Execution Duration Predictor 150 stores predictions of the duration of each task's execution in a Duration database 175. A format of the Duration Database 175 is shown in FIG. 10. Each entry in the database represents statistics of the time it takes a given user to perform a given task. More precisely, each entry consists of a UID 1010, Type 1020, average duration 1030, higher order statistical moments 1040, 1050, 1060, 1070 (e.g., statistical variance) and a User ID 1080.

Based on context about the user, an Availability Predictor 140 stores predictions of the user's availability in an Availability database 172. A format of the Availability database 172 is shown in FIG. 11. Each entry in the database represents an instance of the user's availability consisting of a Time Stamp 1110, Condition 1120, Start Offset 1130, Time Span 1140, Statistics 1150, User ID 1160, and a Pattern ID 1170. A Pattern ID 1170 is a unique identifier of a pattern that is found in a reward packet as defined below. The Condition 1120 of an availability entry indicates the context state that must be satisfied in order for the user to be considered available to engage in a task. The Start Offset 1130 of an availability entry indicates the delay from the current time (now) at which point the user will become available to engage in a task. An example Start Offset might be 30 minutes indicating that in 30 minutes the user will be available to engage in a task. The Time Span 1140 is the duration of a user's availability once his or her availability begins. An example Time Span might be 1 hour indicating that once the user becomes available he or she will be available for 1 hour. The Statistics 1150 represents the statistical characterization of a user's availability. An example value for Statistics might include an accuracy attribute of 90% to indicate that the user will be available as specified with 90% likelihood.

Other context attributes could be generated by one or more context synthesizers 165. For example, using the algorithm described in F. Kargl et al., “Smart Reminder—Personal Assistance in a Mobile Computing Environment,” Workshop on Ad Hoc Communications and Collaboration in Ubiquitous Computing Environments, ACM 2002 Conference on Computer Supported Cooperative Work (CSCW 2002), New Orleans, USA, November 2002, the disclosure of which is incorporated by reference herein, levels of user business can be computed and stored in the Pattern DB Center 170. Using the approach described in S. Hudson et al, “Predicting Human Interruptibility with Sensors: A Wizard of Oz Feasibility Study” Proceedings of the 2003 SIGCHI Conference on Human Factors in Computing Systems (CHI) (2003) available at http://www-2.cs.cmu.edu/˜jfogarty/publications/chi2003.pdf, as well as J. Fogarty et al, “Predicting Human Interruptibility with Sensors,” appearing in ACM Transactions on Computer-Human Interaction, Special Issue on Sensing-Based Interactions (TOCHI) (2004) available at http://www-2.cs.cmu.edu/—jfogarty/publications/tochi2004.pdf, the disclosures of which are incorporated by reference herein, levels of interruptibility can be computed and stored in the Pattern DB Center 170.

General user preferences are also stored in the User Preference 185 database. These preferences could be specified by the end user or by an administrator to define task priorities, task execution duration, availability or other forms of synthesized context.

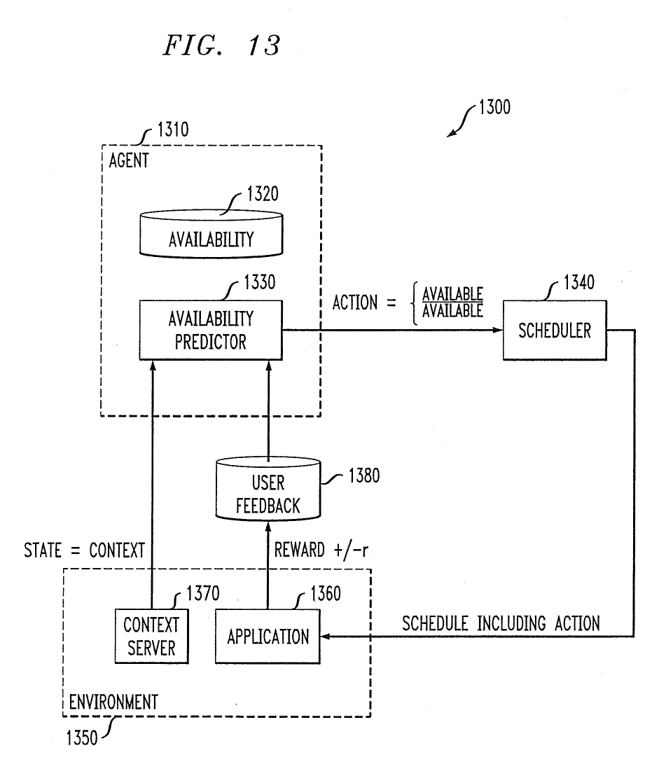

The Scheduler 180 monitors User Preferences 185, the Availability database 172, the Duration database 175 the Priority database 177 and potentially, additional synthesized context obtained from context synthesizers 165 via the Pattern DB Center 170. The Scheduler uses this information to determine how the tasks should be scheduled. The output of the Scheduler 180 is fed into a realization of an application 190 that uses the schedule to impact its output. Output from the application 190 is fed back and stored in a User Feedback database 138. A format of the User Feedback Database 138 is shown in FIG. 12. Each entry in the database represents a feedback event provided by the end user. A reward packet corresponds to an entry in the database and is exchanged in the feedback system 1300. Each feedback event consists of a Type 1210, a Suggested Time 1220, a User Reward 1230, a Time Stamp 1250, an event ID 1260, and a User ID 1270. The Type and event ID fields identify the task on which feedback is reported. The User ID field 1270 tracks the end user. The Suggested Time field 1220 contains the time at which the task was scheduled by the Scheduler 180. Note that this time could be a point in the future. The User Reward field 1230 contains a scalar measuring the user satisfaction with the value of the Suggested Time field 1220 that was generated by the Scheduler 180. This User Reward 1230 defines a reward function as it is commonly done in reinforcement learning (see, e.g., “Machine Learning,” Tom Mitchell, McGraw Hill, 1997, the disclosure of which is incorporated by reference herein). User feedback entries are used in conjunction with context from the Context database 132 to refine the computations made by the availability predictor 140, the execution duration predictor and the task prioritizer 160.

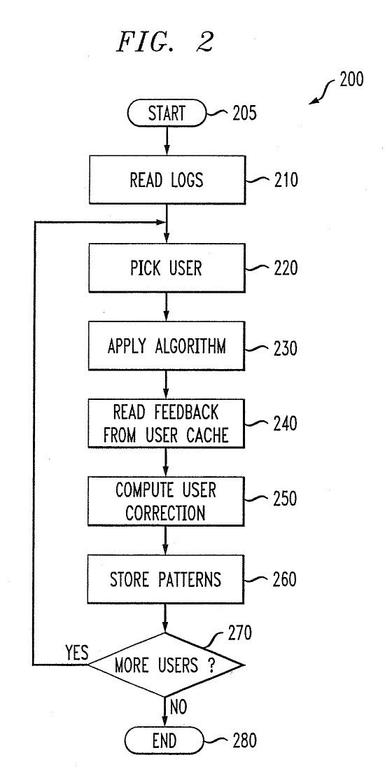

FIG. 2 shows an exemplary method 200 for determining user availability based on context. The method starts (block 205) by reading logs (step 210) of context followed by selecting a particular user (step 220). Once a user has been selected, an algorithm is applied (step 230) to the logged context and feedback from the user's cache is read (step 240). An exemplary embodiment of an algorithm applied to the logged context is a machine learning algorithm (see, e.g., “Machine Learning,” Tom Mitchell, McGraw Hill, 1997). The user data is used to compute necessary corrections (step 250) followed by storing the corrected patterns (step 260). The predictor then determines if context from additional users (step 270) needs to be analyzed. In the case of additional users, the process continues by picking the next user (step 220). In the case of no additional users, the method ends (block 280).

A computation 1300 of the necessary corrections (step 250) is illustrated in FIG. 13. This computation may include an instantiation of the Q-Learning algorithm (see, e.g., “Machine Learning,” Tom Mitchell, McGraw Hill, 1997). The agent 1310 uses its availability predictor module 1330 (which corresponds to module 140 in FIG. 2) to read the current context from the context server 1370 (which corresponds to module 110 in FIG. 2). From the availability database 1320 (which corresponds to module 172 in FIG. 2), the agent 1310 identifies the pattern that should be activated given this state of the current context. From the identified pattern, the agent 1310 outputs an action to the scheduler 1340 (which corresponds to module 180 in FIG. 2). This action predicts the user availability.

As described below, the scheduler 1340 uses this availability prediction to schedule a task for the end user. The result of this prediction could have different effects on the user. The application 1360 (which corresponds to module 190 in FIG. 2) queries the end user to get feedback on the accuracy of the availability prediction and sends a reward packet to the availability predictor 1330. If the prediction is made when the user feels that she is actually available, the reward packet will contain a positive reward in the user reward field 1230. If the prediction was not appropriate, the reward packet will contain a negative reward in the user reward field 1230. Using the Q-Learning algorithm, the availability predictor updates the accuracy of the patterns stored in the availability database 1320.

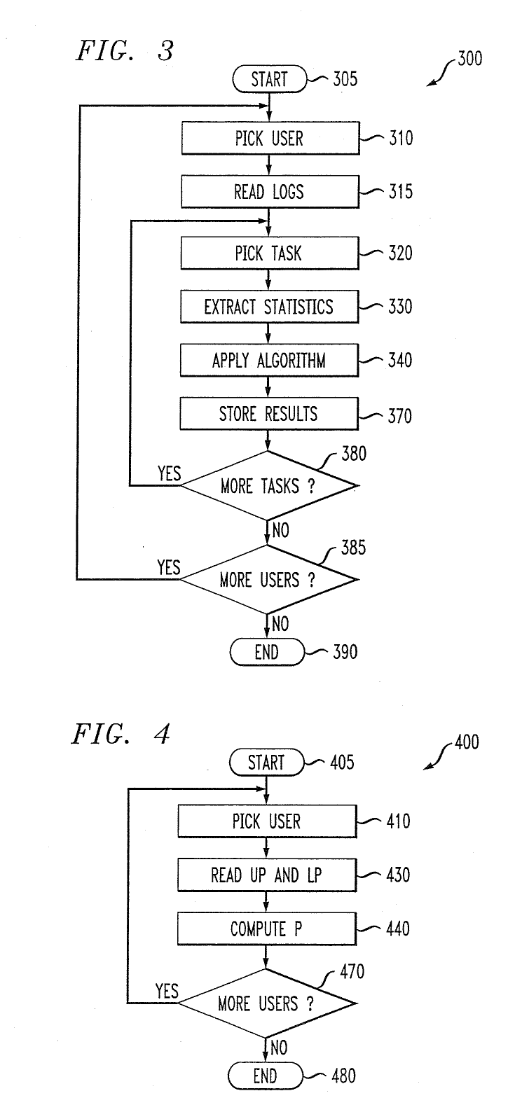

FIG. 3 shows an exemplary method 300 for predicting the duration of a task's execution. The method starts (block 305) by picking a user 310. It then reads the logs of context from the Log DB Center 130 (step 315) to get context logs associated with the selected user. The method then selects a task (step 320) and extracts statistics (step 330) describing the task. An exemplary embodiment of statistics that may be extracted include the moment (mean) of the task's duration based on previous executions of the task.

The method then applies an algorithm (step 340) to the task's statistics to determine the expected duration of the task based on existing conditions. An exemplary algorithm that could be applied to the task's statistics may be a machine learning algorithm (see, e.g., “Machine Learning,” Tom Mitchell, McGraw Hill, 1997). The results of the computation are then stored (step 370). A check is made to determine if additional tasks need to be analyzed (step 380). If there are more tasks to analyze, then another task is selected (step 320). If there are no more tasks to analyze, then the method checks if there are more users to process (step 385). If there are more users to process, then another user is selected (step 310). If there are no more users to process, then the method ends (block 390).

FIG. 4 shows an exemplary method 400 for prioritizing tasks. The exemplary method 400 in FIG. 4 assumes without loss of generality that there are two types of fundamental priorities associated with each task: a user priority (UP) and a learned priority (LP). A user priority is specified a priori by a user to indicate the importance of a task. A learned priority (LP) is determined statistically by observations of a task's execution. Observations may include determination that a user selects a given task over another task and, based on such an observation, the respective tasks' learned priorities are calculated. In this exemplary method, the priority (P) of a task is calculated based on both the user priority and learned priority by taking a weighted sum of UP and LP.

The method starts (block 405) by picking a user (step 410). The specified user priority is then read (step 430) together with the learned priority LP. The priority P is then computed (step 440) as a function of the user and learned priorities. An exemplary function that computes the priority P from the user priority UP and the learned priority LP computes the priority as an average of the user priority and the learned priority. The method then checks for additional users (step 470). If there are additional users, then another user is selected (step 410). If there are no additional users, then the method ends (block 480).

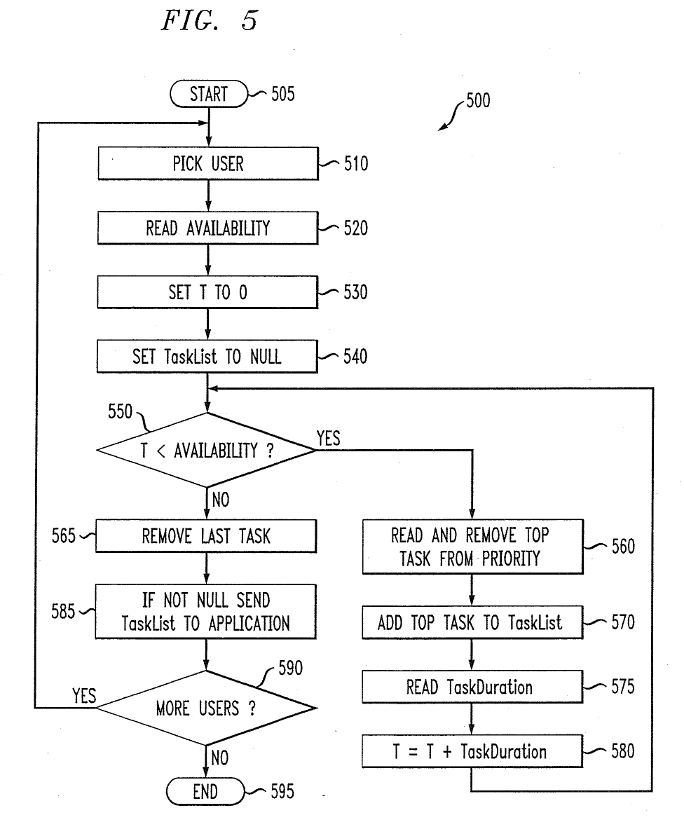

FIG. 5 shows an exemplary method 500 for scheduling tasks. The method starts (block 505) by selecting a user (step 510) followed by reading the availability (step 520) of the selected user. The task time parameter T is set to a value of zero (step 530) and the task list (TaskList) is set to null (step 540). The time parameter T is then compared to the availability of the selected user (step 550). If T is less than the availability (indicating that the user has time to complete the task), then the top task in the task priority database 177 is read and removed (step 560). The task removed from the task priority database 177 is then added to the task list (step 570) and the task's duration (TaskDur) is read (step 575).

A new task time parameter is then calculated by adding the task duration (TaskDur) to the current task time parameter (step 580). The new task time parameter is then compared with the user availability (step 550). In the case in which the task time parameter is not less then the user availability, then it is known that more tasks are scheduled than are possible to accommodate according to the user's availability. In this instance, the most recently added task is removed from the TaskList. Assuming the TaskList is not null (empty), the task is sent to the application (step 585). The method then checks for additional users (step 590). If there are additional users, then another user is selected (step 510). If there are no additional users, then the method ends (block 595). It is to be appreciated that this description of the task scheduler method 500 is exemplary and is representative of one of many possible realizations.

Another embodiment of method 500 may include an Overscheduled Percentage such that the Overscheduled Percentage is a decimal value between 1.0 and 2.0. The Overscheduled Percentage is multiplied by the value of the Availability parameter in method 500 so that the user can have more tasks scheduled than are possible to complete within the available time. This exemplary modification gives the user the option of engaging in tasks that normally would be impossible due to time constraints.

Thus, in accordance with one aspect of the invention, user tasks are assigned fixed attributes (i.e., due date, level of importance and duration) and user context is employed to determine if and when the user has an available time slot for completing the tasks. FIG. 5 illustrates this aspect. The due date, level of importance and duration of tasks are assumed to be specified externally. Without loss of generality, an example of external specification of these values may include direct user input. Given these fixed values, method 500 uses user availability as calculated via method 200 and task priorities as calculated via method 400.

In accordance with another aspect of the invention, user tasks are assigned a fixed due date and a fixed duration and user context is employed to determine the level of importance of the task so that the task can be scheduled appropriately. FIG. 5 illustrates this aspect. The due date and duration of tasks are assumed to be specified externally. Without loss of generality, an example of external specification of these values may include direct user input. Given these fixed values, method 500 uses user availability as calculated via method 200 and task priorities as calculated via method 400.

In accordance with yet another aspect of the invention, user tasks are assigned a fixed due date and a fixed level of importance and user context is employed to determine the duration of the task so that the task can be scheduled appropriately. FIG. 5 illustrates this aspect. The due date and level of importance of tasks are assumed to be specified externally. Without loss of generality, an example of external specification of these values may include direct user input. Given these fixed values, method 500 uses user availability as calculated via method 200, task duration as calculated via method 300 and task priorities as calculated via method 400.

In accordance with a further aspect of the invention, user tasks are assigned some combination of fixed and varying due date, level of importance and duration such that context is employed to determine some or all of the due date, importance and difficulty attribute values to determine whether or not a task can be prioritized appropriately. As appropriate the due date, level of importance and/or task duration may be specified externally. Without loss of generality, an example of external specification of these values may include direct user input. Given some set of fixed values, method 500 may call upon method 300 to calculate task duration and method 400 to calculate task priority as appropriate. Method 200 calculates user availability.

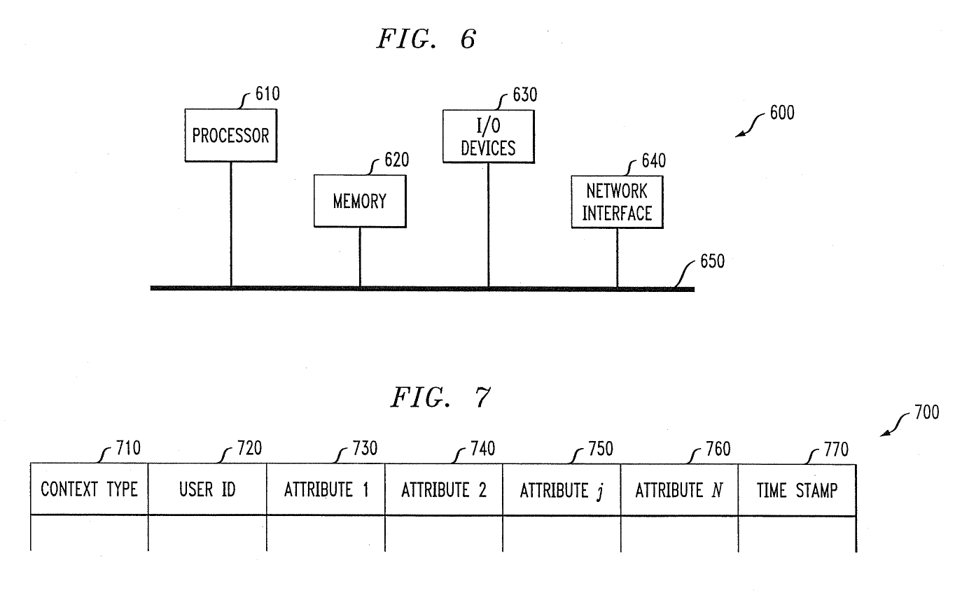

Referring finally to FIG. 6, a block diagram illustrates a computer system in accordance with which one or more components/steps of a task management system (e.g., components/steps described in accordance with FIGS. 1 through 5 and 7 through 13) may be implemented, according to an embodiment of the present invention.

Further, it is to be understood that the individual components/steps may be implemented on one such computer system, or more preferably, on more than one such computer system. In the case of an implementation on a distributed system, the individual computer systems and/or devices may be connected via a suitable network (e.g., the Internet or World Wide Web). However, the system may be realized via private or local networks. The invention is not limited to any particular network.

As shown, the computer system 600 may be implemented in accordance with a processor 610, a memory 620, I/O devices 630, and a network interface 640, coupled via a computer bus 650 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., speaker, display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

It is to be further appreciated that the present invention also includes techniques for providing task management services.

By way of example, a service provider agrees (e.g., via a service level agreement or some informal agreement or arrangement) with a service customer or client to provide task management services. That is, by way of one example only, the service provider may host the customer's web site and associated applications. Then, in accordance with terms of the contract between the service provider and the service customer, the service provider provides task management services which may include one or more of the methodologies of the invention described herein. By way of example, this may include automatically scheduling tasks for a user, based on context, given a set of tasks and their attributes and a set of user available time slots, so as to provide one or more benefits to the service customer. The service provider may also provide one or more of the context sources used in the process. For example, the service provider may provide location context, or electronic calendar services.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer-based method of scheduling at least one task associated with at least one user, comprising the steps of:
obtaining context associated with the at least one user; and
automatically determining a schedule for the at least one user to perform the at least one task based on at least a portion of the obtained context and based on one or more task attributes associated with the at least one task.

2. The method of claim 1, further comprising the step of automatically formatting the schedule for use within a personal information management tool of the at least one user.

3. The method of claim 1, wherein one of the one or more task attributes comprises a task due date, a level of task importance, and a task duration.

4. The method of claim 2, further comprising the step of obtaining the availability of the at least one user through at least one of a user specification and an analysis algorithm applied to obtained user context.

5. The method of claim 2, wherein the step of automatically determining a schedule further comprises determining at least one of the one or more task attributes wherein at least one attribute of the attributes is determined using user context.

6. The method of claim 5, wherein context comprises at least one of a location of the user, calendar information of the user, an availability of the user, a workload of the user, a temperature of an environment of the user, one or more network resources available to the user, a device profile that the user has access to, and an identity of a person within a vicinity of the user.

7. The method of claim 3, wherein the step of automatically determining a schedule further comprises assigning a fixed value to at least one of the task due date, the level of task importance, and the task duration so as to determine the schedule.

8. The method of claim 3, wherein the step of automatically determining a schedule further comprises varying a value of at least one of the task due date, the level of task importance, and the task duration so as to determine the schedule.

9. The method of claim 3, wherein the step of automatically determining a schedule further comprises assigning a fixed task due date and a fixed task duration and using user context to determine the level of task importance so that the task can be scheduled.

10. The method of claim 3, wherein the step of automatically determining a schedule further comprises assigning a fixed task due date and a fixed level of task importance and using user context to determine a task duration so that the task can be scheduled.

11. The method of claim 3 wherein the step of determining a task duration is obtained explicitly from a user.

12. The method of claim 3, wherein the step of determining a task duration is learned from a history of one or more previous task executions from the user.

13. The method of claim 3, wherein the step of automatically determining a schedule further comprises determining at least one of the one or more task attributes wherein at least one attribute of the attributes is explicitly specified by the user via one or more preferences.

14. The method of claim 4, wherein the step of obtaining availability of the user comprises applying a Q-learning algorithm to at least a portion of the user context.

15. A computer-based method of scheduling at least one task associated with at least one user, comprising the steps of:
assigning the at least one user task one or more fixed attributes; and
employing user context to determine if and when the user has an available time slot for completing the at least one task.

16. A computer-based method of scheduling at least one task associated with at least one user, comprising the steps of:
assigning the at least one user task a fixed due date and a fixed duration; and
employing user context to determine a level of importance of the task so that the task can be scheduled appropriately.

17. A computer-based method of scheduling at least one task associated with at least one user, comprising the steps of:
assigning the at least one user task a fixed due date and a fixed level of importance; and
employing user context to determine a duration of the task so that the task can be scheduled appropriately.

18. A computer-based method of scheduling at least one task associated with at least one user, comprising the steps of:
assigning the at least one user task a combination of fixed and varying due date, level of importance and duration attributes; and
employing user context to determine a whether or not the task can be prioritized appropriately.

19. Apparatus for scheduling at least one task associated with at least one user, comprising:
a memory; and
at least one processor coupled to the memory and operative to: (i) obtain context associated with the at least one user; and (ii) automatically determine a schedule for the at least one user to perform the at least one task based on at least a portion of the obtained context and based on one or more task attributes associated with the at least one task.

20. An article of manufacture for use in scheduling at least one task associated with at least one user, comprising a machine readable medium containing one or more programs which when executed implement the steps of:
obtaining context associated with the at least one user; and
automatically determining a schedule for the at least one user to perform the at least one task based on at least a portion of the obtained context and based on one or more task attributes associated with the at least one task.

21. A method of providing a task management service, comprising the step of:
a service provider providing a task management system operative to: (i) obtain context associated with at least one customer; and (ii) automatically determine a schedule for the at least one customer to perform at least one task based on at least a portion of the obtained context and based on one or more task attributes associated with the at least one task.
